(19) United States
(12) Patent Application Publication
(10) Pub. No.: US 2003/0081853 A1
(43) Pub. Date: May 1, 2003

(54) Automated document stamping

(76) Inventors: Bruce L. Johnson, Eagle, ID (US); Leonard T. Schroath, Boise, ID (US); Bradley J. Anderson, Boise, ID (US); William I. Herrmann, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/002,572

(22) Filed: Nov. 1, 2001

(51) Int. Cl. G06K 9/40

(52) U.S. Cl. 382/254

(57) ABSTRACT

Input print media is received at a printing device. In response to a request from a user to stamp routing information on the print media, the print media is stamped with the routing information. This stamping may be stamping of the received print media, or alternatively the received print media may be unaltered and another print media output having printed thereon the content of the received print media and the routing information.

### TECHNICAL FIELD

This invention relates generally to printing and scanning, and more particularly to automated document stamping.

### BACKGROUND

As computer technology has advanced so too has the technology used in peripheral devices available to computers, resulting in an increase in the types of peripheral devices available to computers as well as improvements of those different types. For example, where relatively slow dot matrix printers having poor print quality were once the norm, now black and white as well as color ink and laser printers having vastly improved print speeds and print quality are commonplace.

The technological advances in computing and related peripheral devices have led to the desire for a “paperless” office (or at least an office with a significantly reduced amount of paper usage). The idea behind a paperless office is to replace traditional hard copies (e.g., sheets of paper) with soft copies (electronic versions of hard copies). This reduces the amount of paper used in an office, can improve communication because of the faster rate at which electronic data can typically be communicated, and reduces physical storage requirements (typically less storage space, whether it be magnetic disk or optical disk or some other format, is required for electronic copies than for paper copies).

One problem encountered in establishing a paperless office is that the entire company performing the transition to the paperless office may not be ready at the same time. Some locations may be ready to make the transition prior to others (whether it be due to physical limitations such as the need for new equipment, or even personnel issues as some employees may resist the transition), and purchasing decisions may need to be made based on whether a particular location is paperless or not.

One specific example of this transition problem is the processing of office forms. Many offices use a wide variety of forms, with the specific forms being dependent on the office itself as well as the type of business the office is in. Examples of such forms include work orders, purchase orders, invention disclosure forms, etc. A common function in processing such forms is to assign a tracking number to the form and optionally information about the form (e.g., “approved”, “rejected”, “pay”, etc.). Currently, such information needs to be manually stamped on the form using an ink pad and conventional rubber stamp. This can be a rather user-unfriendly task, as the ink and rubber stamp can be messy and, if a tracking number is used, may require manual logging of the tracking number. One solution to this problem is to create an electronic version of such forms and have them processed electronically. However, new software may need to be developed by the company in order to automatically generate certain parts of the information, such as tracking number. Furthermore, using electronic forms can create problems when transitioning to paperless offices as it typically leaves no hard copy of the forms.

Thus, it would be beneficial to provide a mechanism that makes such a transition to a paperless office more user-friendly and less burdensome.

### SUMMARY

Automated document stamping is described herein.

According to one aspect, input print media is received at a printing device and, in response to a request from a user to stamp routing information on the print media, is stamped with routing information. Other content can also be printed on the media (e.g., content received from a remote device).

In one implementation, the routing information is stamped on the input print media. In another implementation, the input print media is unaltered but another input print media has printed thereon both the routing information as well as the content on the original input print media.

According to another aspect an electronic copy of the input media is generated and stamped with the routing information, and then the stamped electronic copy is communicated to another device (e.g., for storage in electronic form).

### BRIEF DESCRIPTION OF THE DRAWINGS

FIGS. 1a and 1b are block diagrams illustrating exemplary environments employing automated document stamping.

FIG. 2 illustrates an exemplary printing device that automatically stamps documents.

FIG. 3 is a flowchart illustrating an exemplary process for automatically stamping documents and generating electronic copies.

FIG. 4 illustrates another exemplary printing device that automatically stamps documents.

FIG. 5 is a flowchart illustrating an exemplary process for automatically stamping documents.

FIG. 6 illustrates portions of an exemplary printing device in additional detail.

### DETAILED DESCRIPTION

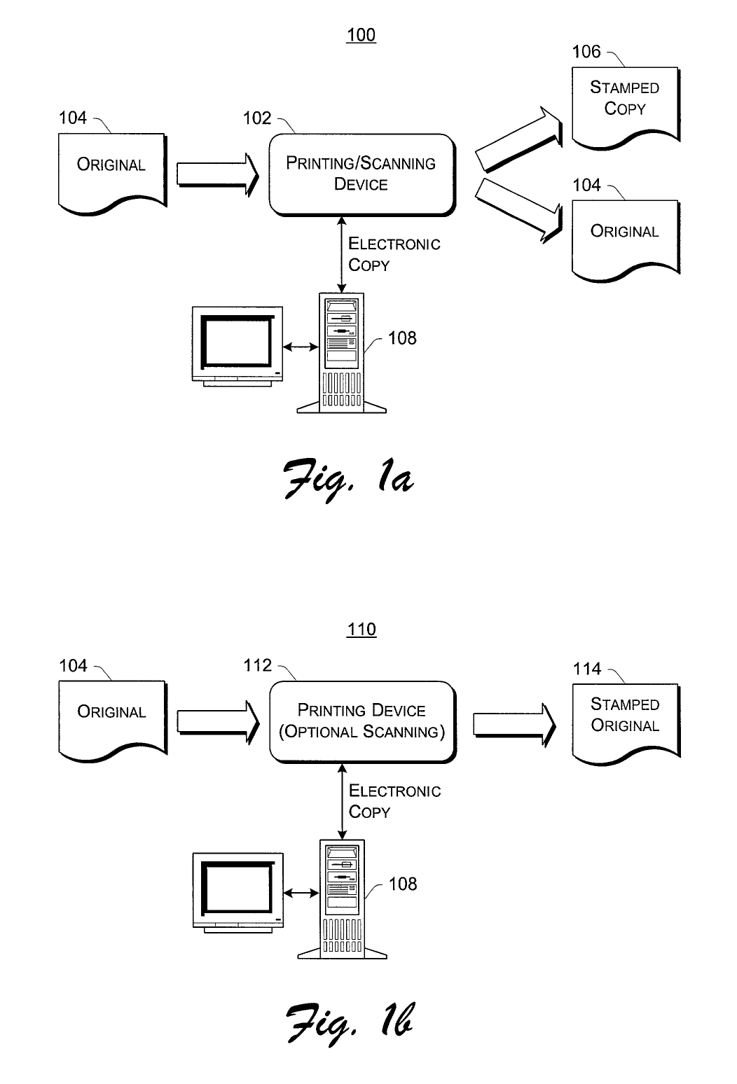

FIGS. 1a and 1b are block diagrams illustrating exemplary environments employing automated document stamping. Environment 100 of FIG. 1a includes a printing and scanning device 102 that is capable of operating in a conventional manner to receive print requests from one or more computing devices (not shown) and printing the requested information. Printing device 102 is also capable of receiving an original document 104 and a “stamp” command (e.g., via an input key or keypad of device 102). Upon receipt of the stamp command, device 102 generates an electronic copy of document 104, stamps the electronic copy, and outputs the original document 104 as well as a stamped copy 106. Stamped copy 106 has printed thereon the same content as original document 104, as well as the additional stamped information.

Environment 110 of FIG. 1b includes a printing device 112 that optionally operates as a scanning device as well. Printing device 112 is capable of receiving original document 104 and a stamp command (e.g., via an input key or keypad of device 112). Upon receipt of the stamp command, device 112 stamps original document 104, and outputs stamped original 114. If device 112 also operates as a scanning device, then an electronic copy of document 104 is also generated.

Original document 104 can be input to device 102 or 112 in hard copy form (e.g., a piece of paper or other print medium), or alternatively in electronic form (e.g., a document received as part of a print request from a remote device, or received via a facsimile transmission from another device). If document 104 is received in an electronic form, device 102 generates a hard copy of the electronic document without a stamp (as original 104) and a hard copy of the electronic document with the stamp (as stamped copy 106). Device 112, on the other hand, generates one hard copy of the electronic document—a copy with the stamp.

In environments 100 and 110, the electronic stamped copy (if any) is communicated to a computing device 108. Situations can exist where there is no stamped electronic copy to send to device 108, such as when device 112 does not have any scanning ability and receives an input in hard copy form. Computing device 108 can use the electronic stamped copy in whatever manner it desires, such as for storage of the electronic stamped copy (e.g., at device 108 or optionally another database (not shown)).

Devices 102 and 112 may also have additional functionality, such as the ability to send a scanned document as a facsimile and/or receive original document 104 via a facsimile transmission from another device. In such situations, the stamping of documents can be incorporated into the facsimile functionality as well, such as to stamp a document received via a facsimile transmission, or to stamp the original document that has been transmitted by facsimile.

Thus, in order to process a document, the user need simply insert the document as original 104 and input the “stamp” command (e.g., press “stamp” button on device 102 (or 112)). The form is then accepted by device 102 (or 112) and the routing information (e.g., tracking number, date, and any other information requested by the user or programmed into device 102 (or 112)) is added to the form. A hard copy of the form including the routing information is output (as stamped copy 106 (or stamped original 114)) in order to maintain a paper copy with the routing information, and (optionally) an electronic copy (with routing information) is communicated to device 108 for storage of the “paperless” copy.

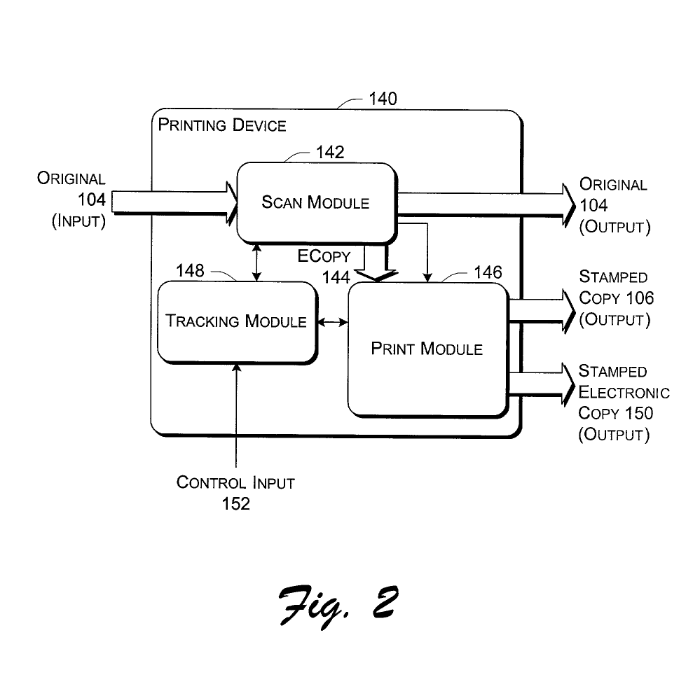

FIG. 2 illustrates an exemplary printing device 140 that automatically stamps documents. Printing device 140 includes the ability to scan documents, such devices often being referred to as “multifunction” devices. Printing device 140 includes a scan module 142, a print module 146, and a tracking module 148. Various functionality of these modules 142, 146, and 148 can be implemented in hardware, software, firmware, or alternatively combinations thereof.

An original document 104 is input and made available to a scan module 142 of device 140. Scan module 142 operates in a conventional manner to scan the input document 104 to generate an electronic copy of document 104 (shown as ecopy 144). This electronic copy 144, also commonly referred to as a soft copy, is a digital representation of the content on input document 104 and can typically be used by printing device 140 or other printing and/or computing devices to display or print a copy of document 104. Scan module 142 can use any of a wide variety of formats to store electronic copy 144, including both public and proprietary formats. Examples of such formats include JPEG (Joint Photographic Experts Group), TIFF (Tagged Image File Format), a bitmap, etc. Additionally, scan module 142 may support monochrome scanning and/or color scanning.

The input mechanism of printing device 140 via which document 104 is input to device 140 can vary. Examples of such input mechanisms include a substantially flat piece of glass or other transparent material that document 104 can be placed on page by page (commonly referred to as a flatbed scanner), or an input mechanism that can accept one or more pages concurrently and feed them to scan module 142 for scanning (commonly referred to as a sheet fed scanner).

Once original document 104 is scanned, scan module 142 outputs document 104 in unaltered form. In other words, document 104 is input to device 140, scanned to generate electronic copy (ecopy) 144, and then output without any modification of (e.g., stamping of) original 104.

In some situations, original document 104 is input to printing device 140 already in an electronic form, in which case scan module 142 need not generate ecopy 144. For example, original document 104 may be received via a facsimile transmission and converted to digital form by a facsimile module (not shown), or received in digital form from a remote computing device. In certain implementations, the digital format in which original document 104 is received may not be the desired format for ecopy 144, in which case a module of printing device 140 (e.g., scan module 142) converts the document in its received format to the desired format.

Electronic copy 144 of document 104 is communicated to print module 146. In situations where original document 104 is received in electronic form, print module 146 may optionally output an unstamped hardcopy of original document 104 (as there is no original hardcopy for scan module 142 to output). Print module 146 receives an indication from tracking module 148 of what routing information is to be stamped on ecopy 144. Tracking module 148 may provide this information to print module 146 in response to a request from print module 146, or automatically (e.g., based on receipt of the stamp command, or an indication from scan module 142 that a new document is being scanned). For example, when a new document 104 is input to scan module 142 and a stamp command is input to device 140 (e.g., a stamp key on device 140 is depressed), tracking module 148 may receive that indication and communicate the appropriate routing information to be stamped on document 104 to print module 146, which in turn stamps the received routing information to the next electronic copy of a document it receives from scan module 142.

The routing information to be stamped on a document is determined by tracking module 148. Any of a wide variety of routing information can be stamped on a document. Examples of such routing information include: current date and/or time, an already decided upon disposition of the document (e.g., approved, rejected, return to author for elaboration, etc.), a next course of action to be taken for the document (e.g., if approval is needed, names or titles of one or more people that need to approve the document, whether a meeting needs to be set to discuss the document, etc.), a tracking number for the document (e.g., a disclosure number, a work order number, a purchase order number, etc.), an indication of the individual stamping the document (e.g., the user's initials, name, title, etc.), and so forth. It is to be appreciated that the specific routing information stamped on a particular document is dependent on where printing device 140 is being used (e.g., the type of business being conducted) as well as the desires of the user(s) of original document 104.

Tracking module 148 can be programmed with an indication of how it is to generate the routing information and/or the routing information may be supplied to module 148. Tracking module 148 can be programmed to generate routing information in a variety of manners. For example, module 148 may keep track of the current date and time that can be accessed when stamping a document, or module 148 may keep track of the last tracking number it used and increment (e.g., by one) the tracking number each time it stamps a document. Routing information may also be supplied to module 148 as control input 152. Control input 152 can be received from a variety of different sources including remote devices (e.g., a computing device coupled to printing device 140 via a network or other wired or wireless connection) which may be located in the same room as device 140 or anywhere else. Control input 152 may also be received as a direct input from an input mechanism of printing device 140. Any of a variety of input mechanisms may be used, such as a conventional keypad, a series of menus that are scrolled through using one or more keys and the current menu selection displayed (e.g., on an LCD screen), a touch screen input, voice input, etc. In one implementation, printing device 140 includes one or more programmable keys that can be programmed by the user to perform certain functions, such as stamp with tracking number, stamp with tracking number and date, stamp with the date and user's initials, etc. These keys can be programmed in a variety of conventional manners, such as via a key pad (including one key for each letter of the alphabet or alternatively fewer keys (e.g., tap a key once for one letter and twice for another letter)), from a remote device, etc.

A single key or input may be used to initiate the automated stamping process (e.g., user-selection of one of the programmable keys implicitly requests that the process begin). Alternatively, a separate “stamp” or “go” key or command may be used, allowing the user to, for example, toggle on and off various stamping options by repeated depressing of particular keys, and then beginning the automated stamping process when the “stamp” or “go” key is depressed. Alternatively, a stamp command may be issued from a remote device, such as a computing device coupled to printing device 140.

Print module 146 can be configured to stamp the routing information anywhere on the document (e.g., centered at the top, in the upper or lower right-hand comer, and so forth). Print module 146 can receive this location information along with the routing information from tracking module 148, or alternatively be pre-configured with this location information. Pre-configuring print module 146 with location information can be performed in one or more of a variety of different manners, such as the manufacturer of device 140 preconfiguring print module 146 with a default location, the user (or an administrator) entering location information via an input key pad of device 140, the user (or an administrator) entering location information via another computing device coupled to printing device 140 (e.g., coupled via a network connection), etc.

Alternatively, the location at which the routing information is stamped may be dependent on the content of document 104. For example, print module 146 may analyze the content of document 104 in any of a variety of conventional manners to determine locations where there is content on document 104 (whether it be text, graphics, lines, etc.) and locations where there is white space (that is, space with no content printed thereon). These locations of white space can then be used as a basis for determining where the routing information is stamped (e.g., so the routing information is stamped in an area that is white space or at least predominately white space). In one implementation, print module 146 is pre-configured with a default location for the stamp that is overridden in favor of a secondary location if there is insufficient white space at the default location.

Once the routing information is received and the location where the routing information is to be stamped is known, print module 146 stamps ecopy 144 with the routing information at that location. A printed hard copy is then output by print module 146 as stamped copy 106. Since ecopy 144 is an electronic copy, the stamping involves print module 146 adding the routing information to ecopy 144. This adding of the routing information to ecopy 144 can be performed in a variety of manners. In one implementation, ecopy 144 is a raster image and the routing information is generated as an overlay on the raster image for printing. The routing information may also be a dithered overlay in order to avoid obliterating the content of the original document. The exact manner in which the routing information is added to ecopy 144 varies depending on the specific format in which ecopy 144 is saved. For example, in one implementation where ecopy 144 is a bitmap, print module 146 generates a bitmap for the routing information and overwrites selected pixels in the bitmap of ecopy 144 (those pixels that are at the locations where the stamp is to be placed) with the corresponding pixels from the bitmap for the routing information.

The stamped electronic copy of the document is also output by print module 146 as stamped ecopy 150. Stamped ecopy 150 can be sent to any of a wide variety of different devices in any of a wide variety of different manners. For example, stamped ecopy 150 may be electronically mailed (emailed) to one or more specified email recipients (e.g., which may be specific users, or automated processes for archiving stamped ecopy 150 and/or recording of stamped ecopy 150 in a database), a public or proprietary connection protocol may be used for communicating one or more data packets including stamped ecopy 150 to another device identified by address (e.g., by IP (Internet Protocol) address) or device name, and so on. Print module 146 can be configured to transmit stamped ecopy 150 to any conventional computing device capable of receiving electronic communications (e.g., either wired or wireless communications), such as server or desktop computers, dedicated database computers, RAID systems, network appliances, personal digital assistants (PDAs), cellular phones, etc.

The operation of printing device 140 is further illustrated in the following example. Initially, a user of printing device 140 inputs an original document and initiates the automated stamping process (e.g., by pressing a “stamp” key on device 140). The original document is scanned by device 140 and is output from device 140 unaltered. Additionally, a copy of the original document is also output by device 140 that is the same as the original document but that includes the routing information stamped thereon. An electronic copy of the original document with the routing information stamped thereon is also communicated to another computing device for storage of the “paperless” copy.

It should be noted that the modules 142, 146, and 148 illustrated in FIG. 2 are exemplary only. In alternate embodiments, operations performed by the modules 142, 146, and 148 may be performed by different ones of the modules, or alternatively additional modules. For example, an additional “stamping module” may be included in printing device 140 that receives the routing information from tracking module 148 and stamps the routing information to the electronic copy of the scanned document, and then forwards the stamped electronic copy to print module 146 for printing. By way of another example, the functionality of print module 146 and tracking module 148 may be combined into the same module, or print module 146 may be separated into multiple modules (one to handle printing and the other to handle outputting of the stamped electronic copy 150).

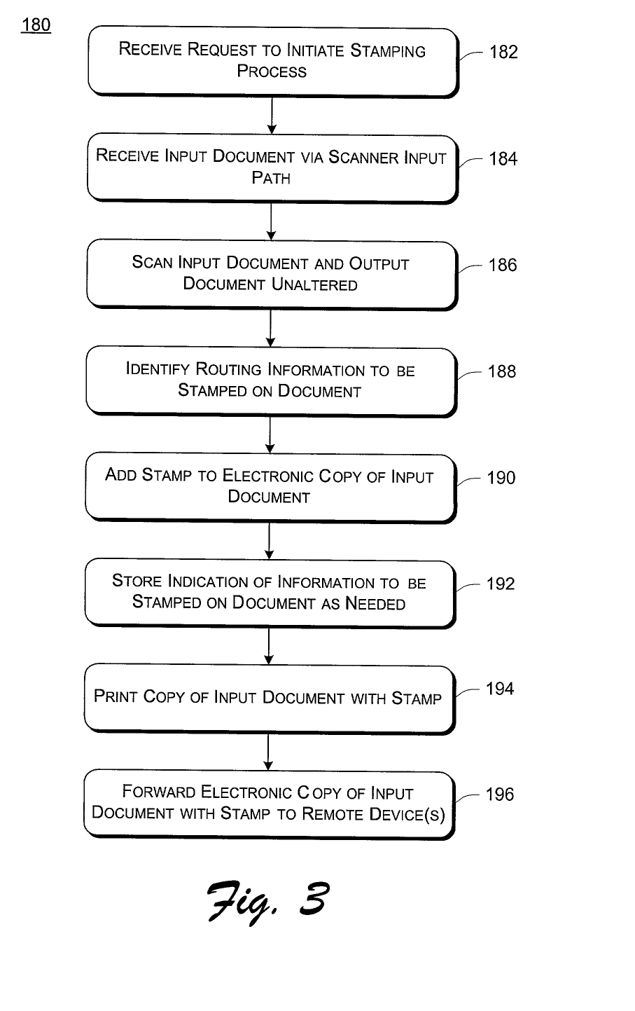

FIG. 3 is a flowchart illustrating an exemplary process 180 for automatically stamping documents and generating electronic copies. The process of FIG. 3 is carried out by a printing device, such as device 140 of FIG. 2, and may be performed in software.

Initially, a request to initiate a stamping process is received (act 182). The document corresponding to the request is received via a scanner input path (act 184), and then scanned into electronic form (if not already in electronic form) and the document output in unaltered form (act 186). The routing information to be stamped on the document is then identified (act 188), and the routing information is stamped on (added to) the electronic copy (act 190). An indication of the routing information stamped on the document is then stored as needed (act 192), such as storing the tracking number so that the next document to be stamped is stamped with a different tracking number. A copy of the stamped document is then printed (act 194), and the stamped electronic copy forwarded to one or more remote devices (act 196).

It should be noted that the acts of process 180 can be implemented in an order different than the order illustrated in FIG. 3. For example, act 186 could be performed concurrent with act 188, or act 194 could be performed prior to, subsequent to, or concurrent with act 196.

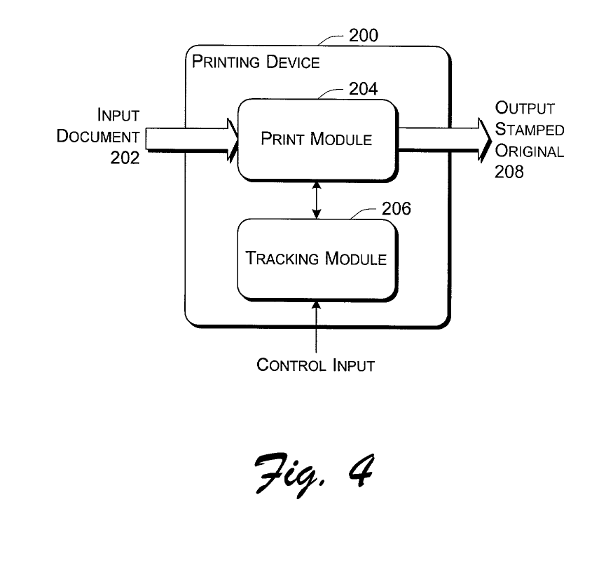

FIG. 4 illustrates another exemplary printing device 200 that automatically stamps documents. Printing device 200 does not include the ability to scan documents (or alternatively if equipped with the ability to scan documents, printing device 200 does not use the ability when automatically stamping documents). Printing device 200 automatically stamps documents similarly to printing device 140 of FIG. 2, except that no electronic copy is generated and that printing device 200 stamps the original document rather than generating a copy with the stamp. It should be noted that, in addition to the automated stamping capability, printing device 200 operates as a conventional printer, receiving print requests from one or more computing devices (either coupled directly to device 200 or via a network) and printing the requested documents.

An original document 202 is input to a print module 204 of device 200. This input is via the conventional print media input path for device 200 (e.g., a manual-feed tray or an auto-feed tray). Print module 204 receives an indication from a tracking module 206 of what information is to be stamped on original document 202. Tracking module 206 operates analogous to tracking module 148 of FIG. 2 to identify what information is to be stamped on a document, and print module 204 operates analogous to print module 146 of FIG. 2 to determine the location where the stamp is to be placed. Analogous to printing device 140 of FIG. 2, a single key or input may be used to initiate the automated stamping process, or a separate “stamp” or “go” key or command may be used (e.g., to allow various stamping options to be set by the user). Once the stamp command is received, print module 204 prints the indicated stamp on input document 202 at the indicated location, and outputs a stamped original document 208 (which is document 202 plus the stamp). Various functionality of modules 204 and 206 can be implemented in hardware, software, firmware, or alternatively combinations thereof.

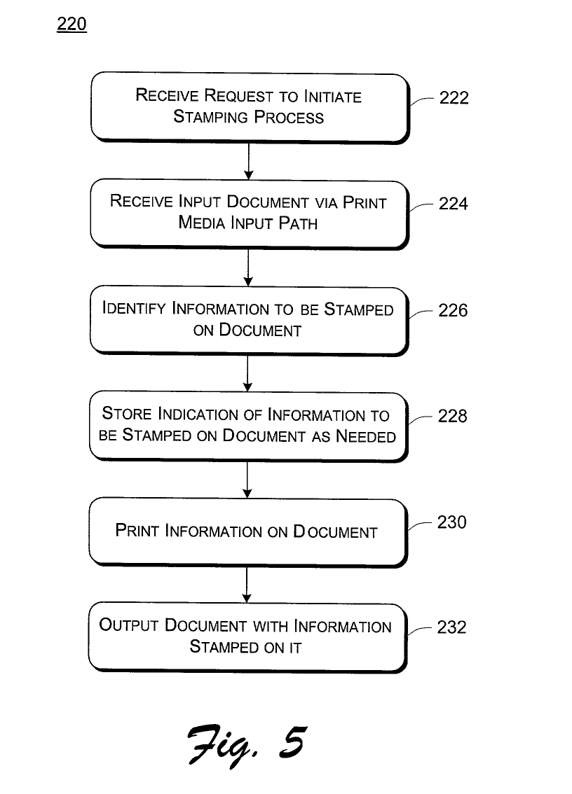

FIG. 5 is a flowchart illustrating an exemplary process 220 for automatically stamping documents. The process of FIG. 5 is carried out by a printing device, such as device 200 of FIG. 4, and may be performed in software.

Initially, a request to initiate the stamping process is received (act 222). The input document is received via the print media input path (act 224), and the routing information to be stamped on the document is identified (act 226). An indication of the routing information to be stamped on the document is stored, as needed (act 228). The routing information is then printed (stamped) on the received document (act 230) and the stamped document output (act 232).

It should be noted that the acts of process 200 can be implemented in an order different than the order illustrated in FIG. 5. For example, act 228 could be performed prior to, subsequent to, or concurrent with act 230.

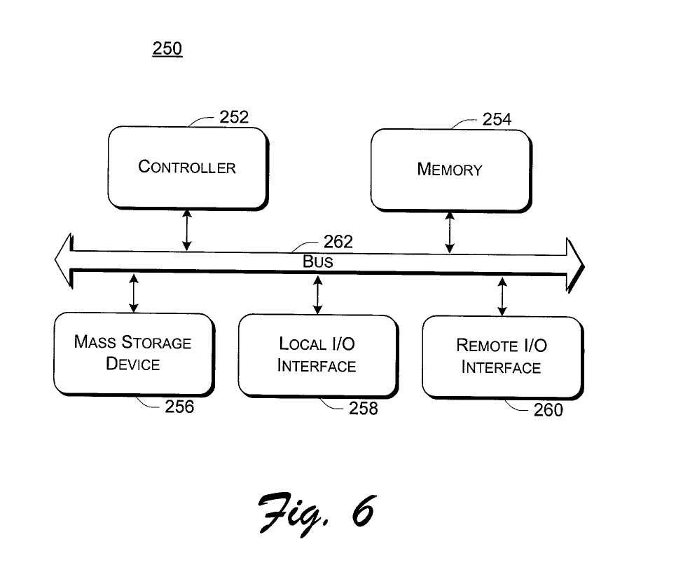

FIG. 6 illustrates portions of an exemplary printing device 250 in additional detail. Device 250 can be, for example, device 102 of FIG. 1a, device 112 of FIG. 1b, printing device 140 of FIG. 2, printing device 200 of FIG. 4, etc. Device 250 represents a wide variety of printing devices, such as laser printers, inkjet printers, thermal printers, dot matrix printers, facsimile machines, multifunction devices (e.g., devices that are a combination of printer, scanner, and facsimile machine), and so forth. Printing device 250 includes a controller 252, a memory 254, a mass storage device 256, a local input/output (I/O) interface 258 (e.g., a keypad), and a remote I/O interface 260, all coupled to a bus 262. Various additional conventional components are also typically included in printing device 250 (e.g., a print engine, print media inputs and outputs, etc.), however, these have not been shown so as to avoid cluttering the drawings.

Controller 252 can be a general purpose microprocessor or a dedicated microcontroller (e.g., one or more Application Specific Integrated Circuits (ASICs) or programmable logic devices (PLDs)). Mass storage device 256 represents any of a wide variety of conventional storage devices, such as fixed or removable magnetic or optical disks, Flash memory, etc. Remote I/O interface 260 is a conventional interface allowing components of device 250 (e.g., controller 252) to communicate with other devices external to device 250. Remote I/O interface 260 may be, for example, a modem, a network interface card (NIC), a parallel port, a universal serial bus (USB) port, and so forth. Bus 262 represents one or more buses in printing device 250, which may implemented be in accordance with public and/or proprietary protocols. The bus architecture can vary by printing device as well as by manufacturer.

Memory 254 represents volatile and/or nonvolatile memory used to store instructions and data for use by controller 252 (e.g., to carry out the functionality of one or more of modules 142, 146, and 148 of FIG. 2, or modules 204 or 206 of FIG. 4. Typically, instructions are stored on a mass storage device 256 (or nonvolatile memory) and loaded into a volatile memory 254 for execution by controller 252. Additional memory components may also be involved, such as cache memories internal or external to controller 252. Various embodiments of the invention may be implemented, at different times, in any of a variety of computer readable media that is part of, or readable by, printer 250. For example, such computer readable media may be mass storage device 256, memory 254, a cache memory, media (e.g., a magnetic or optical disk) accessible to printer 250 via I/O interface 260, and so forth.

Printing device 250 is exemplary only. It is to be appreciated that additional components (not shown) can be included in device 250 and some components illustrated in device 250 need not be included. For example, additional processors or storage devices, additional I/O interfaces, and so forth may be included in device 250, or mass storage device 256 may not be included.

Various discussions herein refer to software components and modules that can be implemented in a printing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving, at a printing device, an input print media;
stamping, in response to a request from a user to stamp routing information on the input print media, the input media with routing information; and
printing, if no request from the user to stamp routing information on the input print media is received, other content on the input print media, wherein the other content is received from a remote device.

2. A method as recited in claim 1, wherein stamping the input media with routing information comprises printing the routing information on the input print media.

3. A method as recited in claim 1, wherein stamping the input media with routing information comprises:
copying the content on the input print media;
outputting the input print media unaltered;
receiving additional input print media; and
printing both the copied content and the routing information on the additional input print media.

4. A method as recited in claim 1, wherein stamping the input media with routing information further comprises determining, based at least in part on content already on the input print media, a location where the routing information is to be stamped.

5. A method as recited in claim 1, wherein stamping the input media with routing information further comprises determining, based at least in part on routing information previously stamped on other print media, the routing information to be stamped on the input print media.

6. A method as recited in claim 1, further comprising:
generating a stamped electronic copy of the input print media by obtaining an electronic copy of the input print media and adding the routing information to the electronic copy of the input print media; and
communicating the stamped electronic copy to a remote device.

7. A method as recited in claim 1, wherein the routing information comprises a tracking number.

8. A method as recited in claim 1, wherein the routing information comprises a date.

9. A method as recited in claim 1, wherein the routing information comprises an identifier that uniquely identifies the input print media.

10. A system comprising:
a print module configured to output a document having particular content thereon, wherein the particular content to be included on the document is dependent on whether a request to stamp information on the document has been received;
a tracking module coupled to the print module and configured to identify, in response to a received request to stamp information on the document, the information to be stamped on the document and to communicate the identified information to the print module; and
wherein the print module is configured to output, if the request to stamp information on the document has been received, the document with the identified information stamped thereon in addition to any other content already on the document, and otherwise to output the document without the identified information stamped thereon.

11. A system as recited in claim 10, wherein the system comprises a printer.

12. A system as recited in claim 10, wherein the system comprises a multifunction device.

13. A system as recited in claim 10, wherein the print module is further configured to generate a stamped electronic copy of the document, wherein the stamped electronic copy of the document includes the identified information as well as any other content already on the document, and to communicate the stamped electronic copy to a remote device.

14. One or more computer readable media having stored thereon a plurality of instructions that, when executed by one or more controllers of a printing device, causes the one or more controllers to perform acts comprising:
stamping, in response to a request from a user to stamp routing information on input print media received at the printing device, the input media with routing information; and
printing, if no request from the user to stamp routing information on the input print media is received, other content on the input print media, wherein the other content is received from a remote device.

15. One or more computer readable media as recited in claim 14, wherein stamping the input media with routing information comprises printing the routing information on the input print media.

16. One or more computer readable media as recited in claim 14, wherein stamping the input media with routing information comprises:
copying the content on the input print media;
outputting the input print media unaltered;
receiving additional input print media; and
printing both the copied content and the routing information on the additional input print media.

17. One or more computer readable media as recited in claim 14, wherein stamping the input media with routing information further comprises determining, based at least in part on content already on the input print media, a location where the routing information is to be stamped.

18. A printer comprising:
an input path via which print media is received;
a tracking module to identify, in response to a stamp command, information to be automatically stamped on the print media; and
a print module, coupled to receive the identified information from the tracking module and to print the identified information on the print media as the stamp if the stamp command has been received, and otherwise, if the stamp command has not been received, to print, on the print media, other content received from a remote source.

19. A printer as recited in claim 18, wherein the print module is further configured to determine, based at least in part on content already on the print media, a location on the print media where the routing information is to be stamped.

20. A printer as recited in claim 18, wherein the printer further comprises a user-selectable stamp button via which the stamp command can be input to the printer.

21. A printer as recited in claim 18, wherein the stamp command is received from a remote device.

22. A system comprising:
a print module configured to output a document having particular content thereon;
a scan module configured to scan an input document and generate an electronic copy of the input document, wherein the electronic copy represents the content of the input document;
a tracking module coupled to the print module and configured to identify, in response to a request for information to be stamped on a document, the information to be stamped on the document and to communicate the identified information to the print module; and
wherein the print module is configured to receive both the electronic copy of the input document from the scan module and the identified information from the tracking module, and to output a stamped hardcopy of the input document including the content from the input document as well as the identified information.

23. A system as recited in claim 22, wherein the print module is further configured to generate a stamped electronic copy by combining the electronic copy of the input document and the identified information from the tracking module, and wherein the tracking module is further configured to send the electronic copy of the input document to a remote device.

24. A system as recited in claim 22, wherein the system comprises a printer.

25. A system as recited in claim 22, wherein the system comprises a multifunction device.

26. A method comprising:
receiving an input document;
scanning the input document to generate an electronic copy of the input document;
adding a stamp to the electronic copy, the stamp comprising routing information for the document;
printing the stamped electronic copy of the document to generate a hard copy of the document with the stamp;
communicating the stamped electronic copy of the document to another device; and
outputting the input document without additional printing thereon.

27. A method as recited in claim 26, wherein the routing information comprises a tracking number.

28. A method as recited in claim 26, wherein the routing information comprises a date.

29. A method as recited in claim 26, wherein the routing information comprises an identifier that uniquely identifies the document.

30. A method as recited in claim 26, further comprising determining, based at least in part on content already on the input document, a location where the stamp is to be added.
